(19) United States
(12) Patent Application Publication
(10) Pub. No.: US 2015/0323167 A1
(43) Pub. Date: Nov. 12, 2015

(54) BULB-TYPE LIGHTING APPARATUS

(71) Applicant: SILICON WORKS CO., LTD., Daejeon-si (KR)

(72) Inventor: Yong Guen KIM, Suwon-si (KR)

(21) Appl. No.: 14/704,138

(22) Filed: May 5, 2015

(30) Foreign Application Priority Data
May 7, 2014 (KR) 10-2014-0054352

(51) Int. Cl. F21V 29/71; F21V 29/83; F21V 17/10; F21V 23/00; F21V 29/67

(52) U.S. Cl. CPC F21V 29/717; F21V 23/005; F21V 29/67; F21V 17/10; F21V 29/83; F21Y 2101/02

(57) ABSTRACT

Provided is a bulb-type lighting apparatus which uses an LED as a light source to improve a heat dissipation structure. The bulb-type lighting apparatus may include heat dissipation bodies in surface contact with a substrate having a semiconductor light emitting device mounted thereon, and dissipate heat of the substrate using the heat dissipation bodies.

### BACKGROUND

1. Technical Field

The present disclosure relates to a lighting apparatus, and more particularly, to a bulb-type lighting apparatus which uses a light emitting diode (LED) as a light source so as to improve a heat dissipation structure.

2. Related Art

Recently, lighting apparatuses using an LED have been developed. The LED is an example of a semiconductor light emitting device, uses a P-N junction of a semiconductor, and emits light through recombination between electrons of the N region and holes of the P region, which is generated by applying a voltage in the forward direction.

The LED generates heat while emitting light. Heat stress caused by the heat generation of the LED may have an influence on a substrate. That is, excessive heat stress may have an influence on not only the emission efficiency and lifetime of the LED, but also elements mounted on the substrate.

Therefore, the lighting apparatus using an LED as a light source needs to have an efficient heat dissipation structure for dissipating heat stress. Furthermore, the heat dissipation structure of the lighting apparatus is required to have a simple structure, while being developed at a low manufacturing cost.

### PRIOR ART DOCUMENT

### Patent Document

(Patent Document 1) Korean Patent Publication No. 10-2012-0054811 (Title: Lighting apparatus)

### SUMMARY

Various embodiments are directed to a bulb-type lighting apparatus which can improve heat dissipation efficiency, have a simple structure, and guarantee a low manufacturing cost.

In an embodiment, a bulb-type lighting apparatus may include: a substrate mounted on one surface of a semiconductor light emitting device; one or more heat dissipation bodies each including a contact plate in contact with the other surface of the substrate and a heat dissipation plate bent from the contact plate; and a housing having an internal space for housing the one or more heat dissipation bodies, wherein the substrate is arranged at an entrance of the internal space of the housing, wherein the heat dissipation body dissipates heat of the substrate using the surface contact between the contact plate and the substrate.

### BRIEF DESCRIPTION OF THE DRAWINGS

FIG. 1 is a perspective view of the bulb-type lighting apparatus in accordance with the embodiment of the present invention.

FIG. 2 is a cross-sectional view of the bulb-type lighting apparatus illustrated in FIG. 1.

FIG. 3 is an exploded perspective view of the bulb-type lighting apparatus illustrated in FIG. 1.

FIG. 4 is a perspective view for describing a coupling state between a substrate and a heat dissipation body in FIG. 3.

FIG. 5 is a perspective view for describing a coupling state between the heat dissipation body and a housing in FIG. 3.

FIG. 6 is a partially cut perspective view of the housing illustrated in FIG. 3.

FIG. 7 is a front view of a bulb-type lighting apparatus in accordance with another embodiment of the present invention.

FIG. 8 is a front cross-sectional view of the bulb-type lighting apparatus illustrated in FIG. 7.

FIG. 9 is an exploded perspective view of the bulb-type lighting apparatus illustrated in FIG. 7.

FIG. 10 is a plan view of a housing of FIG. 7 in a state where a socket is coupled to the housing.

FIG. 11 is a bottom view of a housing of FIG. 7 in a state where the socket is coupled to the housing.

FIGS. 12A to 12C are plan views illustrating other embodiments of a heat dissipation body.

FIG. 13 is a plan view illustrating another embodiment of the heat dissipation body.

### DETAILED DESCRIPTION

Exemplary embodiments will be described below in more detail with reference to the accompanying drawings. The disclosure may, however, be embodied in different forms and should not be constructed as limited to the embodiments set forth herein. Rather, these embodiments are provided so that this disclosure will be thorough and complete, and will fully convey the scope of the disclosure to those skilled in the art. Throughout the disclosure, like reference numerals refer to like parts throughout the various figures and embodiments of the disclosure.

A lighting apparatus in accordance with an embodiment of the present invention may be formed in a bulb type, and emit light using a semiconductor light emitting device. Representative examples of the semiconductor light emitting device may include an LED. Thus, the lighting apparatus in accordance with the embodiment of the present invention may use an LED.

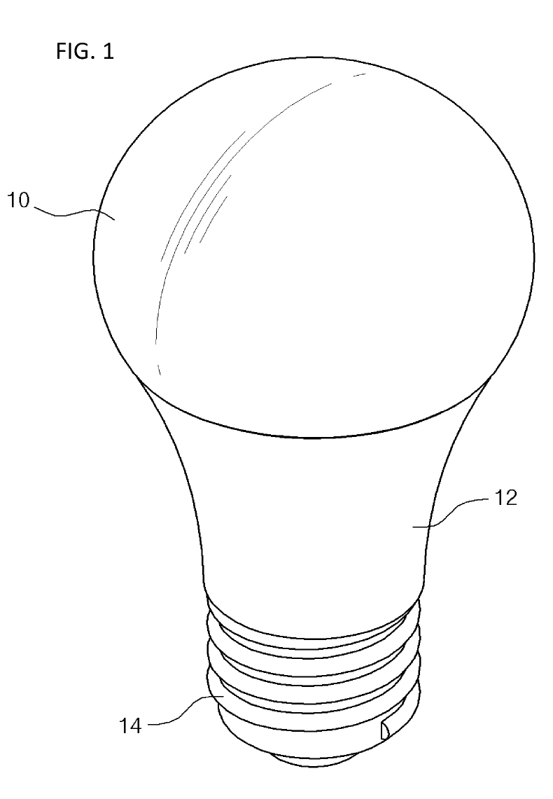

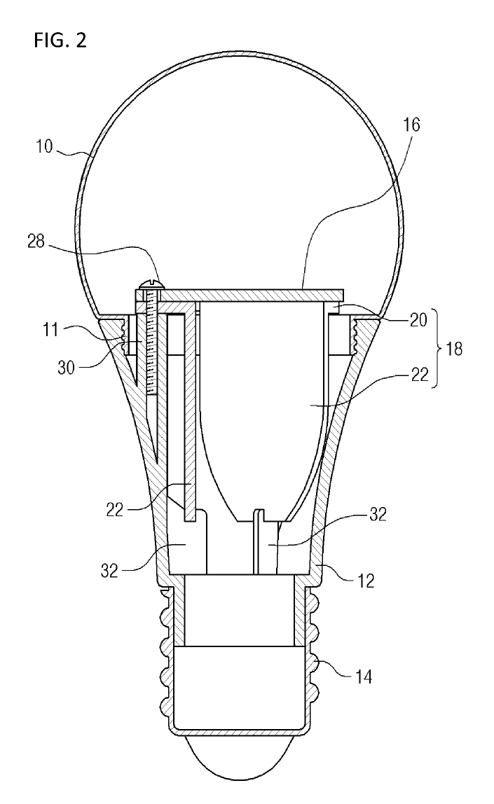

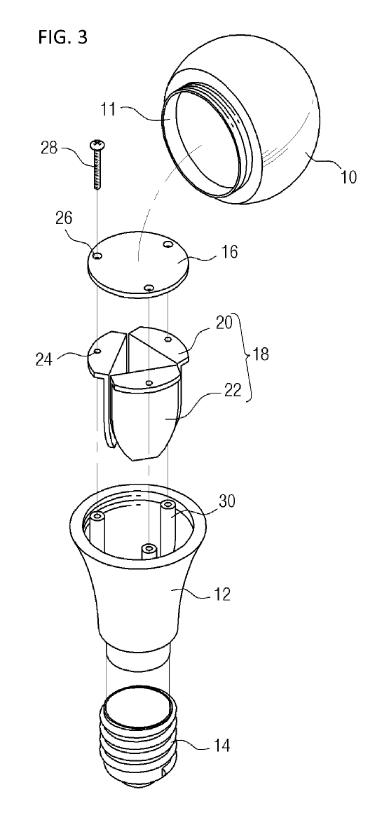

The bulb-type lighting apparatus in accordance with the embodiment of the present invention will be described with reference to FIGS. 1 to 3. FIG. 1 is a perspective view of the bulb-type lighting apparatus in accordance with the embodiment of the present invention, FIG. 2 is a cross-sectional view of the bulb-type lighting apparatus illustrated in FIG. 1, and FIG. 3 is an exploded perspective view of the bulb-type lighting apparatus illustrated in FIG. 1.

The bulb-type lighting apparatus in accordance with the embodiment of the present invention may include a transparent cover 10, a housing 12, a substrate 16, a heat dissipation body 18, and a socket 14, which are coupled to each other. The transparent cover 10 may be coupled to the top of the housing 12, and the socket 14 may be coupled to the bottom of the housing 12. The substrate 16 and the heat dissipation body 18 may be housed in the transparent cover 10 and the housing 12 which are coupled to each other.

The transparent cover 10 capable of transmitting light may be formed in various shapes according to a designer's intention. In the present embodiment, the transparent cover may be formed of glass or plastic in a spherical shape.

The transparent cover 10 may have an opening part through which the transparent cover 10 is coupled to the housing 12. The opening part of the transparent cover 10 may have a screw 11 formed thereon so as to be coupled to the housing 12. For example, the screw 11 of the transparent cover may be implemented as a male screw formed on the outer surface of the transparent cover 10. In response to the male screw, the housing 12 may have a female screw formed on the inner surface of an entrance part thereof. According to the above-described structure, the transparent cover 10 and the housing 12 may be coupled to each other through the screws.

The substrate 16 may have an LED mounted on one surface thereof, and the LED is not illustrated in the drawings. The substrate 16 may include an FR4 substrate or metal substrate. On the one surface of the substrate 16, parts including the LED may be mounted, and electric patterns may be formed. The parts mounted on the substrate 16 may include a current regulation circuit, a power supply circuit and the like. The current regulation circuit may control a current flowing through the LED in order to control light emission, and the power supply circuit may supply a voltage and current for light emission to the LED. The electric pattern may indicate a wiring for electrically connecting the parts, and include one or more layers.

The substrate 16 may be arranged at the entrance part of the housing 12. The substrate 16 may be fabricated using a disk having a smaller diameter than the opening part of the transparent cover 10 or the entrance part of the housing 12. The substrate 16 may include a plurality of screw holes 26 formed therein. The screw holes 26 may be used to couple the substrate 16 to the heat dissipation bodies 18 through screws 28, and the heat dissipation bodies 18 will be described below.

The housing 12 may be formed in various external shapes according to a designer's intention. The exterior of the housing 12 in accordance with the embodiment of the present invention may have an inclined surface. More specifically, the exterior of the housing 12 may have a funnel shape. The housing 12 may be formed of thermal conductive resin having excellent thermal conductivity, and manufactured through a mold process such as injection molding. The thermal conductive resin may include urethane or epoxy-based resin. Furthermore, the housing 12 may be formed of a ceramic material having excellent thermal conductivity.

The housing 12 may have a relatively large diameter at the entrance thereof. That is, the exterior of the housing 12 may have a diameter which gradually decreases away from the entrance. The housing 12 may be coupled to the socket 14 at the opposite end to the entrance thereof.

The housing 12 may have an internal space formed in a vertical direction, and the internal space may include one or more heat dissipation bodies 18.

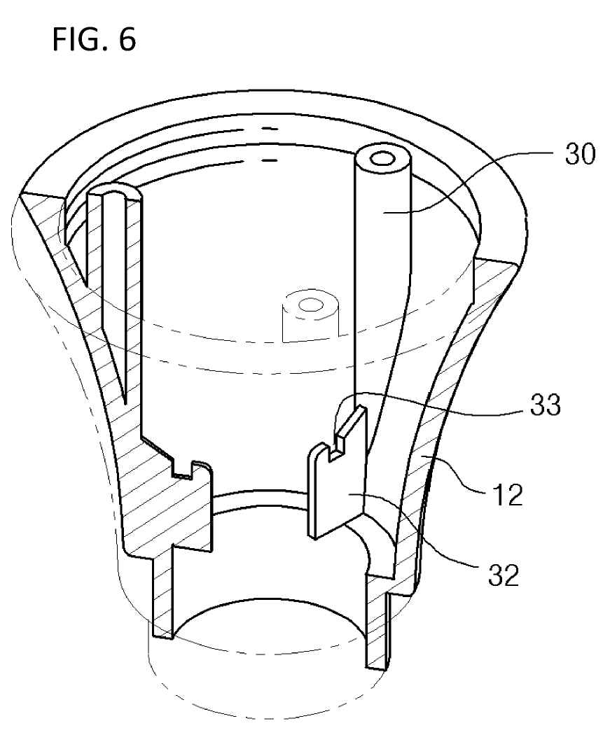

The housing 12 having the internal space formed therein have coupling structures formed on the inner wall thereof so as to be coupled to the heat dissipation bodies 18, respectively. The coupling structures may include protrusion pieces 32, for example. The protrusion pieces 32 may be formed at positions corresponding to the heat dissipation bodies 18 to be described below, and the number of the protrusion pieces 32 may correspond to the number of the heat dissipation bodies 18. Furthermore, the protrusion piece 32 may be vertically erected on the inner wall of the housing 12, and have a fixation groove 33 to which a bottom part of a heat dissipation plate 22 of the heat dissipation body 18 can be inserted and fixed (refer to FIG. 6).

Since the internal space of the housing 12 is relatively wide at the entrance part, the housing 12 may have an inclined inner wall at the entrance part thereof. The housing 12 may have screws 30 extended vertically from the inclined inner wall thereof. The screws 30 may be extended upward in a pillar shape, and have a screw hole formed in the vertical direction. The screws 30 may be formed between the inner wall of the housing 12 and the heat dissipation bodies 18 housed in the inner space of the housing 12. At this time, the number of the screws 30 may correspond to the number of the screw holes 26 of the substrate and the number of the heat dissipation bodies to be described below. The screws 30 may be used for coupling the substrate 16 and the heat dissipation bodies 18, and this structure will be described below.

One or more heat dissipation bodies 18 may be housed in the inner space of the housing 12. In the present embodiment, three dissipation bodies 18 may be housed in the internal space of the housing 12. The heat dissipation bodies 18 may be arranged under the substrate 16.

The heat dissipation body 18 may include a contact plate 20 and a heat dissipation plate 22. The contact plate 20 may be in contact with the other surface of the substrate 16, and the heat dissipation plate 22 may be bent from the contact plate 20. The heat dissipation body 18 may be formed as follows: a disk having a uniform thickness is bent and divided into the contact plate 20 and the heat dissipation plate 22. The contact plate 20 may have the screw hole 24 formed therein. The heat dissipation body 18 may include a metallic disk having excellent thermal conductivity. When the heat dissipation body 18 is bent and divided into the contact plate 20 and the heat dissipation plate 22, a side forming a part of the edge of the top surface of the contact plate 20 may be referred to as a bent side of the heat dissipation body 18.

The contact plate 20 may be in contact with the other surface of the substrate 16, and serve to pump heat of the substrate 16. The heat dissipation plate 22 may serve to dissipate the heat pumped by the contact plate 20. The heat dissipation plate 22 may include one or more of a pin, a protrusion, and an irregularity for improving heat dissipation efficiency. That is, the heat dissipation plate 22 may have a structure which extends the heat dissipation area in order to promote the heat dissipation.

The bulb-type lighting apparatus in accordance with the embodiment of the present invention may be configured as illustrated in FIGS. 1 to 3.

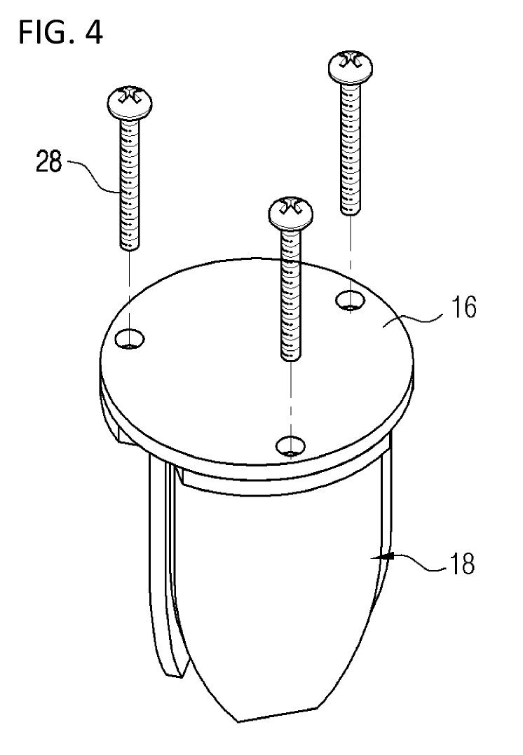

Among the components of the bulb-type lighting apparatus, the substrate 16 and the three heat dissipation bodies 18 may be coupled through a method illustrated in FIG. 4. That is, the three heat dissipation bodies 18 may be aligned in such a manner that the contact plates 20 thereof come in contact with the other surface of the substrate 16, and the substrate 16 and the contact plates 20 of the heat dissipation bodies 18 may be coupled through the screws 28 or ah adhesive. At this time, an adhesive having excellent thermal conduction efficiency may be used to accelerate heat pumping.

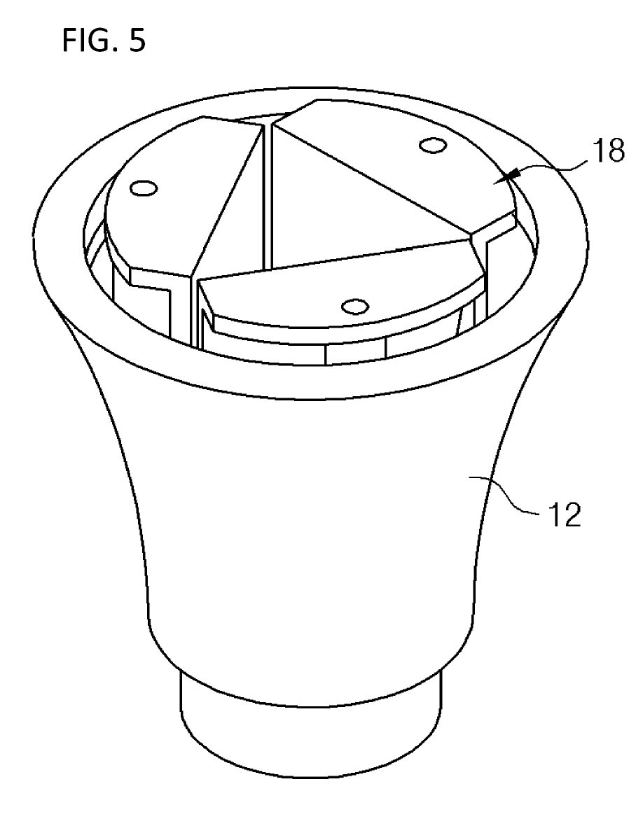

FIG. 5 illustrates the structure in which the three heat dissipation bodies 18 are housed in the housing 12.

In the present embodiment, the three heat dissipation bodies 18 may be arranged to face the center of the internal space of the housing 12. More specifically, the heat dissipation bodies 18 may be arranged in such a manner that the bent sides thereof face the center of the internal space. At this time, the three heat dissipation bodies 18 may be distributed and arranged based on the center of the internal space or distributed and arranged at the outside of the internal space.

Furthermore, the internal space of the housing 12 may be formed as illustrated in FIG. 6. The protrusion piece 32 on the inner wall of the housing 12 may have a fixation groove 33 formed at the top thereof, and the fixation groove 33 may be formed at a position separated from the inner wall of the housing 12. Thus, the heat dissipation plate 22 of the heat dissipation body 18, which is fixed to the fixation groove 33, may be arranged so as to be separated from the inner wall of the housing 12.

Furthermore, although not illustrated, a heat pumping plate for pumping heat may be provided between the substrate 16 and the contact plate 20 of the heat dissipation body 18. The heat pumping plate may serve to accelerate heat dissipation from the substrate 16 to the contact plate 20. In place of the heat pumping plate, a heat conducting sheet or thermal grease may be used.

The bulb-type lighting apparatus in accordance with the embodiment of the present invention may be configured as illustrated in FIGS. 1 to 6, and the heat of the substrate 16 may be pumped into a path including the substrate 16, the contact plate 20, and the heat dissipation plate 22.

The heat dissipation plate 18 in accordance with the embodiment of the present invention may not only be easily assembled to the substrate 16, but also efficiently dissipate heat, while having a simple structure. In order to improve the heat dissipation efficiency, the number of the heat dissipation bodies 18 may be adjusted, and the area of the contact plate 20 of the heat dissipation body 18 may be increased.

In the embodiment of the present invention, the substrate 16 and the contact plate 20 of the heat dissipation plate 18 may be fixed to the screw 30 of the housing 12 through the screw 28. If necessary, however, the heat dissipation body 18 may serve as a medium for fixing the substrate 16 to the housing 12. That is, the substrate 16 and the contact plate 20 of the heat dissipation plate 18 may be coupled to each other through the screw or adhesive, and an end of the heat dissipation plate 22 of the heat dissipation body 18 may be inserted into the fixation groove 33 of the protrusion piece 32 on the inner wall of the housing 12. In this case, the substrate 16 may be coupled to the housing 12 through the heat dissipation bodies 18.

Therefore, the lighting apparatus in accordance with the embodiment of the present invention may improve the heat dissipation efficiency, have a simple structure, and guarantee a low manufacturing cost.

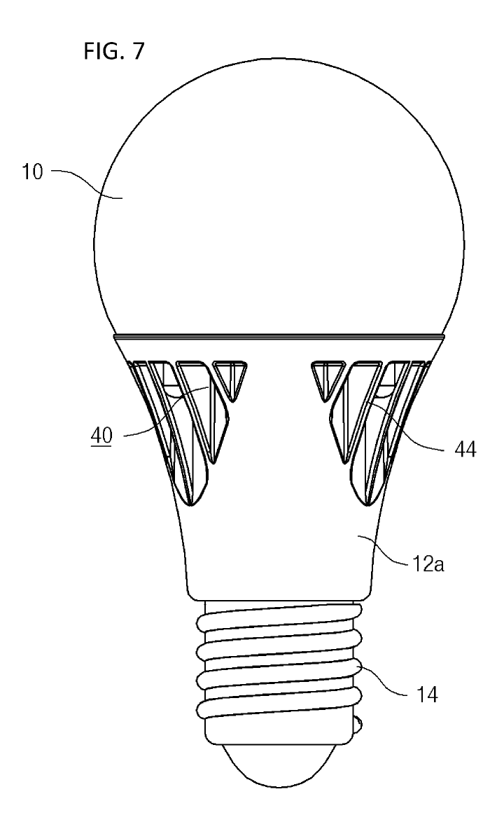

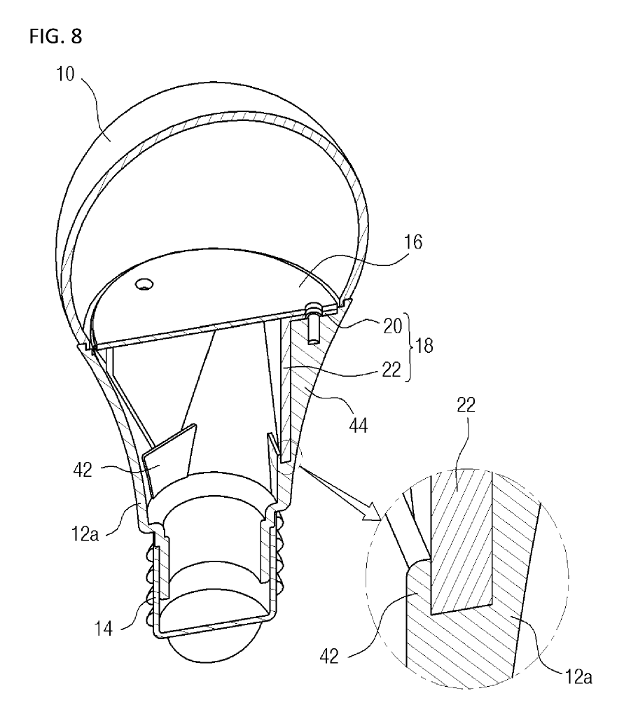

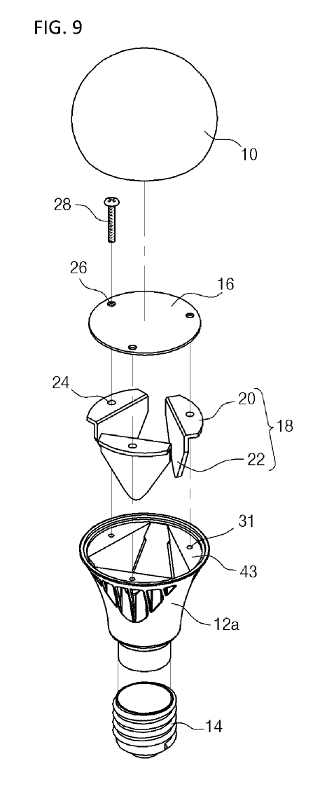

The present invention may be disclosed as another embodiment illustrated in FIGS. 7 to 9. FIG. 7 is a front view of a bulb-type lighting apparatus in accordance with an embodiment of the present invention, FIG. 8 is a front cross-sectional view of the bulb-type lighting apparatus in accordance with the embodiment of the present invention, and FIG. 9 is an exploded perspective view of the bulb-type lighting apparatus in accordance with the embodiment of the present invention. In the embodiment of FIGS. 7 to 9, the same parts as those of the embodiment of FIGS. 1 to 3 are represented by like reference numerals, and the duplicated descriptions thereof are omitted herein.

The embodiment of FIGS. 7 to 9 may include a modified housing 12a.

The housing 12a may include mounting jaws 43 which limits the internal space of the housing 12a and on which the heat dissipation bodies 18 can be mounted, and the mounting jaws 43 may be formed in independent regions corresponding to positions at which the heat dissipation bodies 18 are distributed and arranged.

Furthermore, support jaws 42 for forming a channel may be formed on the inner wall of the housing 12 under the mounting jaws 43.

In the above-described structure, the contact plates 20 of the heat dissipation bodies 18 may be mounted on the mounting jaws 43, and the heat dissipation plates 22 may be in contact with inner walls forming the mounting jaws 43. Furthermore, ends of the heat dissipation plates 22 of the heat dissipation bodies 18 may be partially inserted and fixed to the channel formed by the support jaws 42.

Since the heat dissipation plates 18 are in contact with the mounting jaws 43 formed on the inner wall of the housing 12a, the heat dissipation plates 18 can rapidly dissipate heat of the substrate 16 through the housing 12a. Furthermore, since the housing 12a is formed of thermal conductive resin, the housing 12a may not only pump internal heat to the outside, but also pump the heat of the heat dissipation bodies 18 to the outside.

The mounting jaw 43 may have a screw hole 31 formed at the top surface thereof, and the substrate 16 and the contact plate 20 of the heat dissipation plate 18 may be fixed to the housing 12a through coupling between the screw 28 and the screw hole 31.

The housing 12a may have a heat dissipation space 40 and a rib 44 which are formed on the outer wall thereof, in order to improve heat dissipation efficiency.

At this time, a plurality of ribs 44 may be vertically formed in parallel on the outer wall of the housing 12a, at which the mounting jaws 43 are formed, and the space between the respective ribs 44 may be used as the heat dissipation space 40. That is, the ribs 44 may be formed on the outer wall of the housing 12a, at which the heat dissipation plate 22 is formed.

Since the surface area of the outer wall of the housing 12a is increased by the ribs 44, the heat dissipation efficiency of the housing 12a may be improved in proportion to the increase of surface area. Furthermore, since heat dissipation is efficiently performed through the ribs 44, the ribs 44 may prevent the temperature from rising to high temperature. Thus, the region of the housing 12a, at which the ribs 44 are formed, may have a lower temperature than other regions. Therefore, the ribs 44 of the housing 12a can allow a user to stably hold the lighting apparatus.

Furthermore, the housing 12a may have one or more ventilation holes formed therethrough between the internal space and the outside.

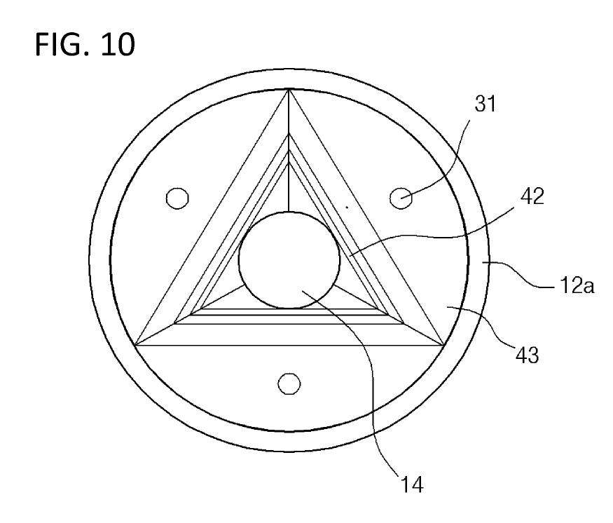

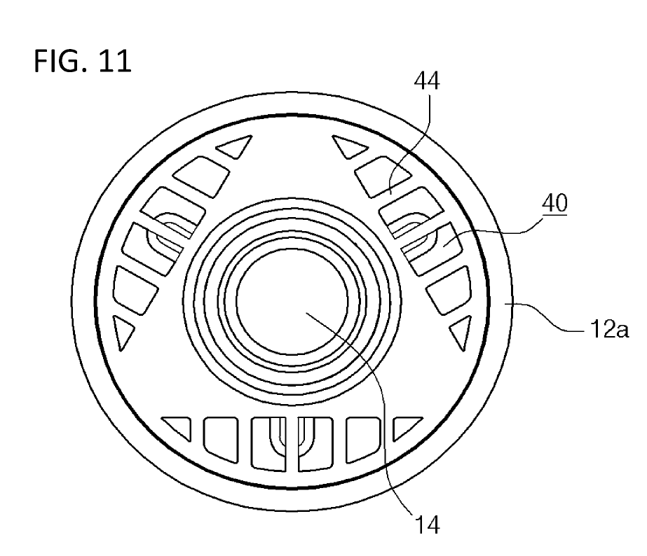

FIGS. 10 and 11 are plan and bottom views of the housing 12a to which the socket 14 is coupled.

The heat dissipation bodies 18 applied to the bulb-type lighting apparatus in accordance with the embodiment of the present invention may be arranged in various manners in the internal space of the housing 12, and the contact plates 20 of the heat dissipation bodies 18 may have various shapes.

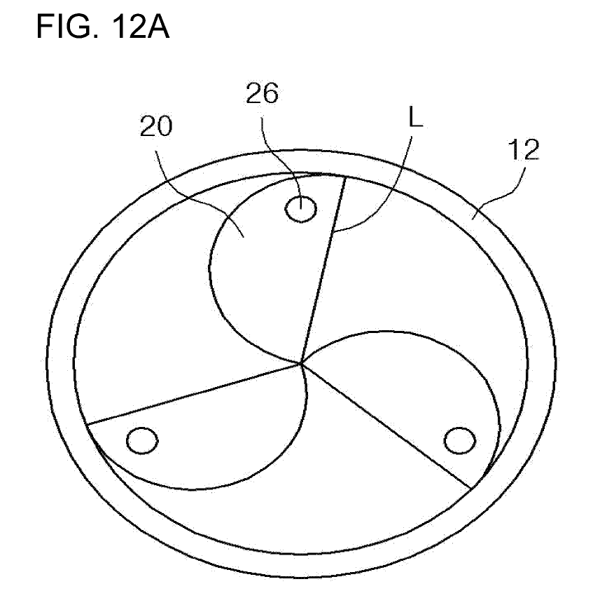

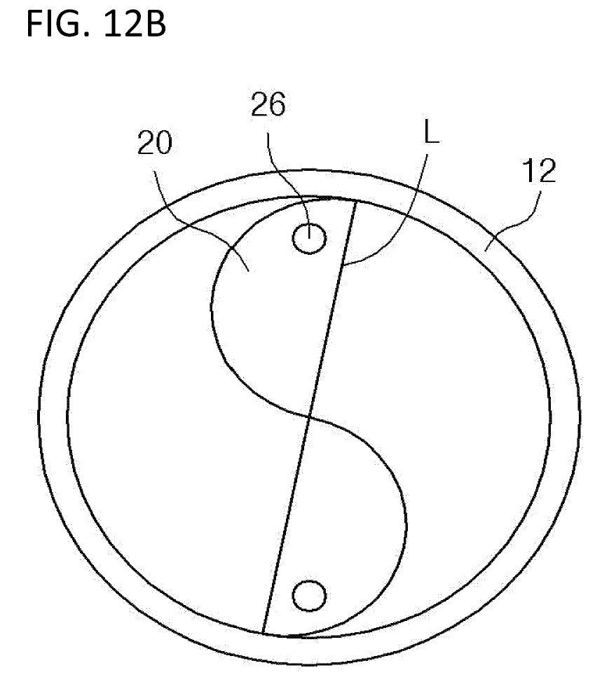

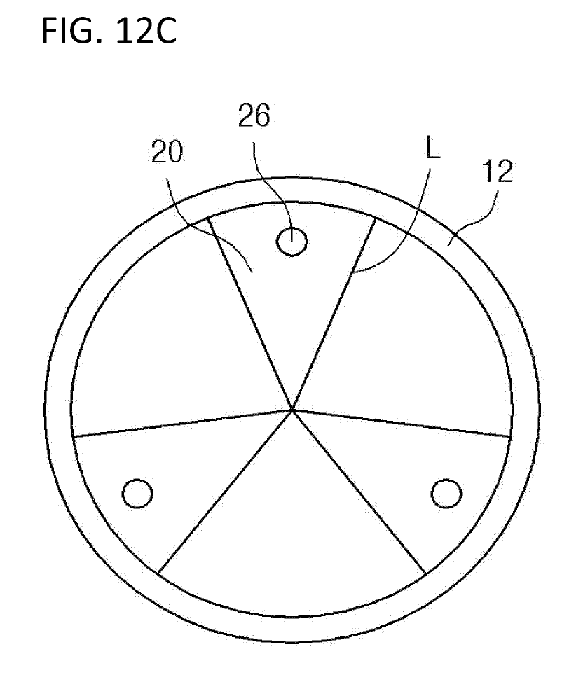

First, as illustrated in FIGS. 12A to 12C, bent sides L of the heat dissipation bodies 18 which are bent and divided into the contact plates 20 and the heat dissipation plates 22 may be arranged radially with respect to the center of the internal space.

FIG. 12A illustrates that bent sides L of three heat dissipation bodies 18 are distributed and arranged with a phase difference of 120°, and FIG. 12B illustrates that bent sides L of two heat dissipation bodies 18 are distributed and arranged with a phase difference of 180°.

Furthermore, as illustrated in FIG. 12C, the heat dissipation plates 22 of the heat dissipation bodies 18 may be formed in a fan shape. In this case, the three fan-shaped heat dissipation bodies 18 may also be distributed and arranged with a phase difference of 120°.

When two or more heat dissipation bodies 18 are formed as illustrated in FIGS. 12A to 12C, two or more heat dissipation bodies 18 may include two or more contact plates having the same shape, and the contact plates 20 may be formed to have an area deviation of 20% or less.

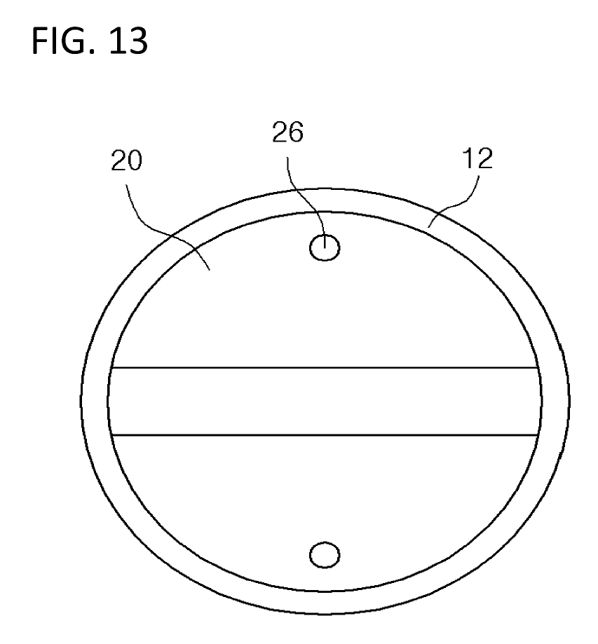

Furthermore, two heat dissipation plates 22 of two heat dissipation bodies 18 may be formed to be symmetrical with each other as illustrated in FIG. 13. In FIG. 13, the contact plates 20 may be distributed and arranged with a phase difference of 180° based on the center of the internal space, and distributed and arranged at the outside of the internal space of the housing 12.

The bulb-type lighting apparatus having the above-described heat dissipation structure may improve the heat dissipation efficiency, have a simple structure, and guarantee a low manufacturing cost.

While various embodiments have been described above, it will be understood to those skilled in the art that the embodiments described are by way of example only. Accordingly, the disclosure described herein should not be limited based on the described embodiments.

What is claimed is:

1. A bulb-type lighting apparatus comprising:
a substrate mounted on one surface of a semiconductor light emitting device;
one or more heat dissipation bodies each comprising a contact plate in contact with the other surface of the substrate and a heat dissipation plate bent from the contact plate; and
a housing having an internal space for housing the one or more heat dissipation bodies, wherein the substrate is arranged at an entrance of the internal space of the housing,
wherein the heat dissipation body dissipates heat of the substrate using the surface contact between the contact plate and the substrate.

2. The bulb-type lighting apparatus of claim 1, wherein the semiconductor light emitting device comprises a light emitting diode (LED).

3. The bulb-type lighting apparatus of claim 1, wherein parts including the semiconductor light emitting device are mounted on the substrate, and an electric pattern is formed on the substrate.

4. The bulb-type lighting apparatus of claim 1, further comprising a heat pumping plate between the substrate and the contact plate,
wherein the heat pumping plate accelerates the heat dissipation.

5. The bulb-type lighting apparatus of claim 1, wherein two or more heat dissipation bodies are arranged in the internal space, and distributed and arranged based on the center of the internal space.

6. The bulb-type lighting apparatus of claim 5, wherein the two or more heat dissipation bodies are distributed and arranged at the outside of the internal space.

7. The bulb-type lighting apparatus of claim 6, wherein the heat dissipation bodies are arranged in such a manner that bent sides of the heat dissipation bodies bent and divided into the contact plates and the heat dissipation plates so as to form a predetermined angle are arranged to face the center of the internal space.

8. The bulb-type lighting apparatus of claim 5, wherein the heat dissipation bodies are arranged in such a manner that bent sides of the heat dissipation bodies bent and divided into the contact plates and the heat dissipation plates are radially arranged.

9. The bulb-type lighting apparatus of claim 8, wherein the contact plate has a fan shape.

10. The bulb-type lighting apparatus of claim 5, wherein two or more of the two or more heat dissipation bodies have the contact plates formed in the same shape.

11. The bulb-type lighting apparatus of claim 5, wherein the contact plates of the two or more heat dissipation bodies have an area deviation of 20% or less.

12. The bulb-type lighting apparatus of claim 1, wherein the heat dissipation body serves as a medium for supporting the substrate with respect to the housing.

13. The bulb-type lighting apparatus of claim 12, wherein the heat dissipation body and the substrate are coupled to each other through any one of a screw and an adhesive.

14. The bulb-type lighting apparatus of claim 1, wherein a coupling structure for coupling the housing and the heat dissipation plate is formed on the inner wall of the internal space.

15. The bulb-type lighting apparatus of claim 14, wherein the housing has a protrusion piece formed on the inner wall thereof and included in the coupling structure, a groove corresponding to the protrusion piece is formed in the heat dissipation plate, and the heat dissipation plate is fixed to the inner wall of the housing through coupling between the protrusion piece and the groove.

16. The bulb-type lighting apparatus of claim 14, wherein the housing has a channel formed therein and included in the coupling structure, and a part of the heat dissipation plate is inserted and fixed to the channel.

17. The bulb-type lighting apparatus of claim 1, wherein the heat dissipation plate comprises one or more of a pin, a protrusion, and an irregularity for the heat dissipation.

18. The bulb-type lighting apparatus of claim 1, wherein the contact plate and the heat dissipation plate are formed by bending a disk with a uniform thickness.

19. The bulb-type lighting apparatus of claim 1, wherein the heat dissipation plate of the heat dissipation body is arranged so as to be separated from the inner wall of the housing.

20. The bulb-type lighting apparatus of claim 1, wherein the heat dissipation plate of the heat dissipation body is arranged to be in contact with the inner wall of the housing.

21. The bulb-type lighting apparatus of claim 1, further comprising a transparent cover coupled to the entrance of the housing.

22. The bulb-type lighting apparatus of claim 1, wherein the housing comprises one or more ventilation holes formed therethrough between the internal space and the outside.

23. The bulb-type lighting apparatus of claim 1, wherein the housing has a rib protruding from the outer wall thereof where the heat dissipation plate is positioned.
